(19) United States
(12) Patent Application Publication
(10) Pub. No.: US 2006/0152379 A1
(43) Pub. Date: Jul. 13, 2006

(54) Self contained monitoring circuit and an electrical appliance incorporating such circuit

(76) Inventor: Thomas John Lewis, Liskeard (GB)

Correspondence Address: Vincent L Ramik;Diller Ramik & Wight, 7345 McWhorter Place, Suite 101, Annandale, VA, 22003, US

(21) Appl. No.: 10/527,405

(22) PCT Filed: Sep. 11, 2003
(86) PCT No.: PCT/GB03/03956

§ 371 Date: Feb. 10, 2006

(30) Foreign Application Priority Data
Sep. 11, 2002 (GB) 0220970.8
Jan. 6, 2003 (GB) 0300187.2
Jun. 28, 2003 (GB) 0315185.9

(51) Int. Cl. G08B 21/00

(52) U.S. Cl. 340/679

(57) ABSTRACT

A self-contained alarm device for monitoring the supply status of a monitored electrical appliance for connection in the supply line from the network to the appliance characterized in that it has no internal power source or battery and is operable to provide an audible and/or visible alarm signal if the electrical power to the appliance is interrupted after connection.

The present invention relates generally to a self-contained monitoring circuit, and to an electrical appliance incorporating such a circuit. In particular the present invention relates to a device incorporating a circuit which is capable of monitoring the continuity of supply delivered through an electrical socket.

Electrical monitoring circuits for detecting continuity of supply are known as such. For example, the so-called “uninterruptable power supply” (UPS) devices supplied for computers operate, among other things, to detect a failure in the supply continuity, and to provide a computer with a battery-generated power supply for a limited time period during which the mains power is not available. A signal connection between the UPS and the computer triggers the computer to shut down in its normal “safe” mode. This is necessary because computers operate with electronic data which may be corrupted if the computer is merely switched off whilst operating. UPS devices are substantial in size, of significant expense, and require to be interconnected between the socket outlet of a power supply and a dedicated input of the computer. However, there are other items of equipment for which continuity of electrical supply is of significance, although not of such great significance that it justifies the cost of an expensive monitoring circuit of the UPS type.

For example, a refrigerator or freezer requires continuity of supply in order to maintain its contents in a cool, or frozen, state and although a short interruption in the power supply may not be disastrous, as it may be in the case of a computer, an extended interruption in the power supply could result in the contents of the freezer or refrigerator warming to such an extent that they become unsafe to use or at least should not be re-frozen.

The present invention seeks to provide an alarm device which is simple and economical, and which, although not providing a back-up power supply in the event of failure or interruption, will nevertheless be capable of alerting a user to the situation so that appropriate remedial action can be taken as necessary. This device may be in an electrical plug, on an adaptor, or incorporated into an electrical appliance.

The present invention seeks to provide an alarm device which is simple and economical, which can be incorporated into an electrical appliance and which, although not providing a back-up power supply in the event of failure or interruption, will nevertheless be capable of alerting a user to the situation so that appropriate remedial action can be taken as necessary.

The present invention also seeks to provide a device for monitoring the continuity of an electrical power supply, which is capable of producing an alarm indication (either audible or visual) if an unexpected or inadvertent interruption in the power supply should occur whereby to alert a user. This may happen, for example, because the incorrect switch of a bank of power supply switches has been thrown, for example in circumstances where a multiple socket has a number of plugs with connections leading to a number of different consumers. In a domestic environment, for example, a freezer, washing machine, tumble drier and other domestic electric appliances may all be connected to a bank of sockets having associated switches. If, intending to switch off the power supply to a washing machine, the switch on the plug leading to the freezer were inadvertently thrown there would be no indication of this error until warming of the freezer contents were noted, by which time it may be too late. The same applies if the mains power supply fails. Usually, however, in such circumstances other electrical appliances such as lighting, heating and radio or television also cease to function providing an indication to alert the user to the circumstance. Moreover, in this case, little, if anything, can be done to mitigate the consequences. However, the device of the present invention is operable to detect all conditions and provide an output indication if the power supply to a monitored appliance is interrupted for any reason.

In its broadest aspect, therefore, the present invention provides a self-contained alarm device for monitoring the supply status of a monitored electrical appliance, which device requires no battery or internal power supply, but which can be connected in the supply line from the mains network to the appliance itself, and is operable to provide an audible and/or visible alarm signal if the electrical power to the appliance is interrupted after connection of the device.

The absence of an internal power supply or battery is important because it entirely avoids the risk that the alarm should fail to sound upon occurrence of an alarm event due to the battery or other power source being discharged or otherwise failing.

In one embodiment of the invention the alarm device is formed as an adapter having electrical pins for insertion into a socket of a mains network, and having socket connections for receiving the pins of a connector plug of the monitored appliance. This embodiment is presently preferred since it can be used at different times for different appliances, is simple to implement and requires no user-input for wiring the device into the system to be monitored. Alternatively, however, the device may be incorporated into a plug for connection to the lead from the appliance If such plugs are provided by OEM's (originally equipment manufacturers) then, again, no additional work is required by the user, although provision of plugs fitted with such circuit devices for retrofitting to equipment is possible and within the scope of the present invention. In such an embodiment it is preferred that the monitoring circuit is housed in the back of a three-pin plug, with contacts allowing electrical connection to be made to the “live” and “neutral” pins of the plug.

Ideally the circuit device is provided with means for detecting an open-circuit condition of a monitored supply line. This may include a delay timer for delaying activation of an output device triggering the alarm indication for a predetermined delay period after detection thereof. This delay period avoids the emission of spurious or unnecessary alarm indications if, for example, the plug is being withdrawn simply to be repositioned, or if a disconnection effected by throwing the switch is deliberate and temporary. The delay period may be anything from a few seconds to a few minutes, and may be adjustable to allow adaptation of the device to different appliances having different requirements. A delay of an hour or more may be appropriate in some circumstances where a delay of a few seconds is sufficient in others.

Furthermore the device may be so arranged that a single short sound is produced immediately upon detection of failure of the supply followed by the delay period and then the alarm signal generated over a longer time period. This is of particular value if a number of protected appliances are connected at a single bank of sockets as it allows a user to withdraw a plug experimentally if the wires are tangled or otherwise difficult to trace, and then listen to establish from which appliance the sound emanates. For this purpose it is also possible to make the sounds different, preferably adjustable in pitch or in the mark-to-space ratio of an intermittent sound, allowing the user to discriminate between different appliances even if it is not immediately apparent where the sound emanates from. Thus the refrigeration could have a rapid series of tones, a freezer a longer spacing between short tones, and a dishwasher a shorter spacing between long tones. A washing machine by contrast may have a high-pitched tone, regardless of any pattern of interruptions, and a tumble dryer may have a low-pitched tone.

Solid state components can be produced in miniaturised form sufficient to enable the device to be fitted into the space available within an electrical plug of conventional 2 dimensions or within an electrical appliance without requiring any change to the external dimensions. Electro-mechanical devices may also be incorporated and, for example, the output device in particular may be a relay or a solid state switching device such as a field-effect transistor. The self-contained alarm device preferably incorporates a capacitor which is maintained charged when the supply is present and which discharges when the supply is removed, whereby to provide a sensing signal detectable by an appropriate detection circuit and usable as the parameter to indicate the interruption of the power supply.

The open circuit condition may be detected, for example, by sensing a reversal in the polarity of a voltage differential across a resistive element.

Various embodiments of the invention will now be more particularly described, by way of example, with reference to the accompanying drawings, in which:

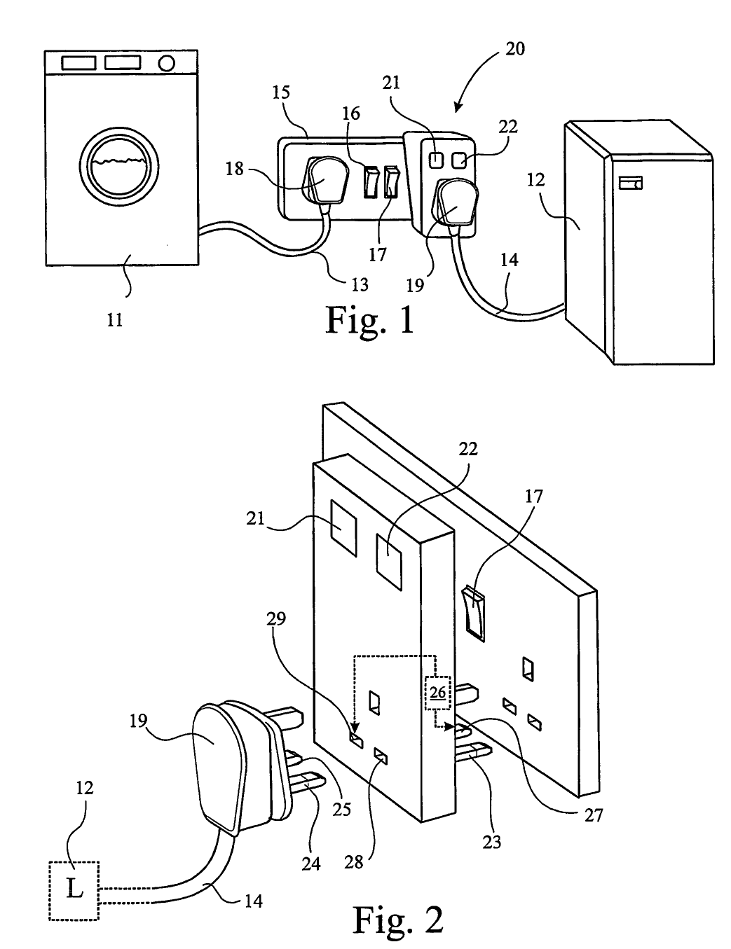

FIG. 1 is a schematic view of electrical appliances connected to the mains supply via monitoring devices formed as first and second embodiments of the present invention;

FIG. 2 is a schematic exploded view of first embodiment of the present invention positioned between an electrical socket outlet and a connector plug for an appliance;

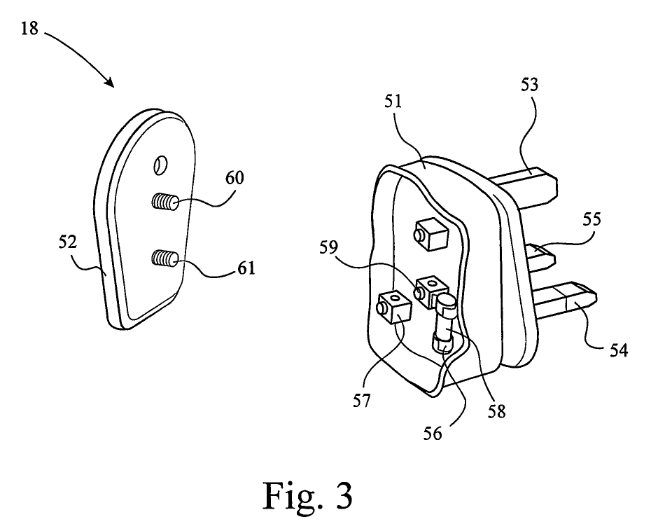

FIG. 3 is a schematic view of a second embodiment of the invention formed on a plug;

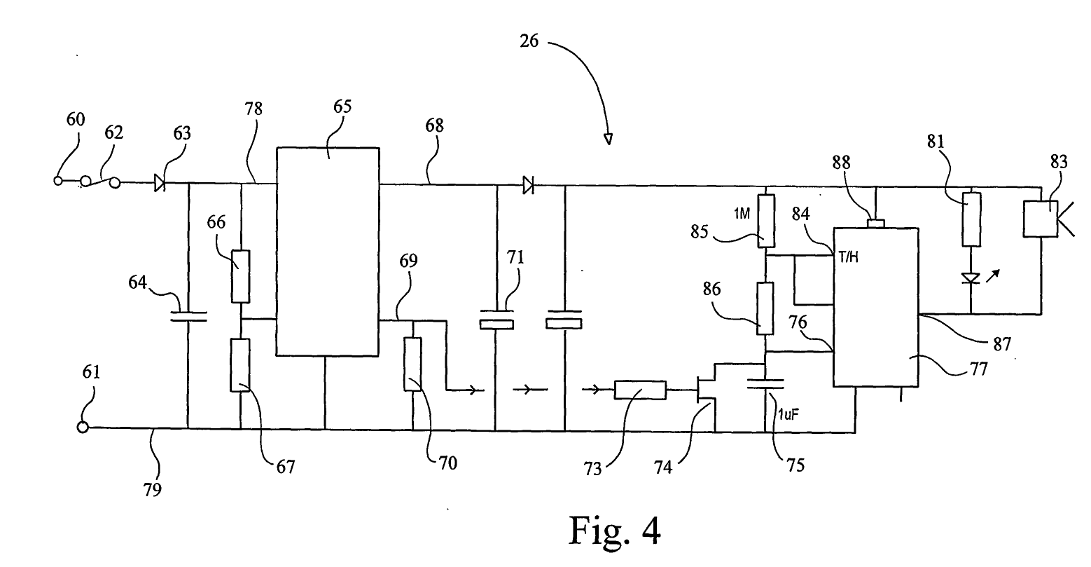

FIG. 4 is a schematic circuit diagram of a circuit which may be incorporated in the adaptor of FIGS. 1 and 2 on the plug of FIG. 3; and

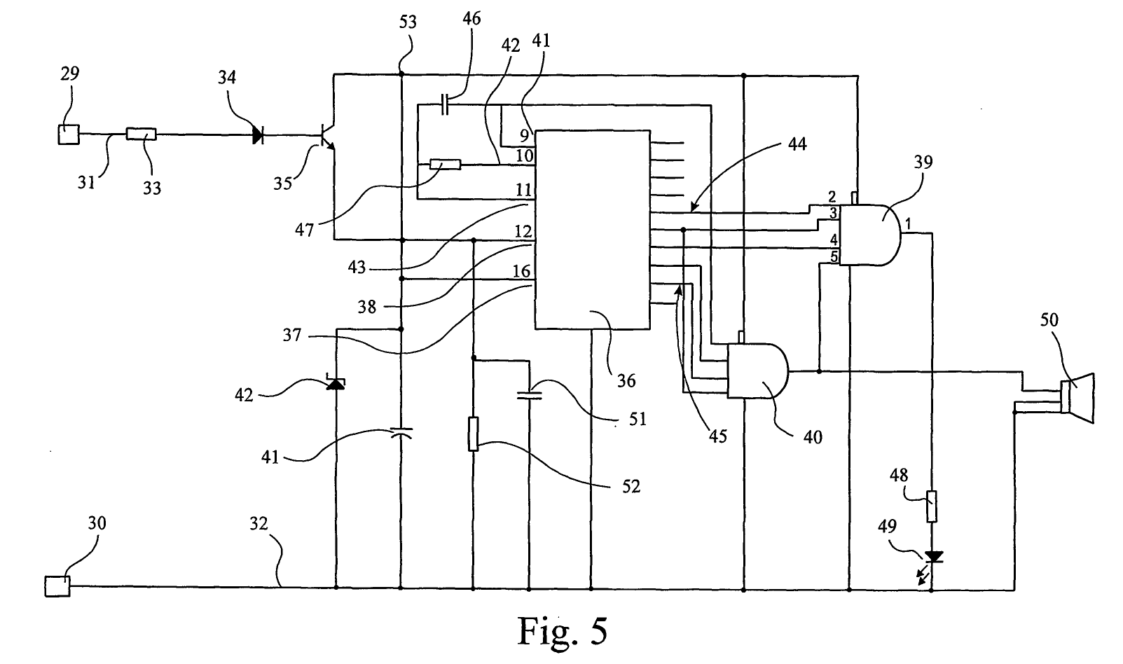

FIG. 5 is a schematic circuit diagram of an alternative circuit formed as an embodiment of the invention.

Turning now to the drawings, FIG. 1 illustrates a typical situation in which the monitoring device of the present invention may be utilised. Here, a washing machine generally indicated 11 and a domestic freezer generally indicated 12 are connected by respective leads 13,14 to a double outlet socket 15 having respective rocker switches 16, 17 for controlling connection and disconnection of the power supply from a mains network (not illustrated) to respective socket outlets on either side of the switches.

The freezer is shown connected to the socket outlet 15 by a plug 19 via the interception of a monitoring device 20 formed as a first embodiment of the invention, having a visible indicator lamp 21 and an audible alarm outlet (microphone or buzzer) 22, and the washing machine 11 is shown connected to the socket outlet 16 by a plug 18 formed as a second embodiment of the invention.

As can be seen in FIG. 2, a live pin 23 of the monitoring circuit 20 connects directly to a live pin 24 of the plug 19 which is electrically connected via the load, in this case a freezer 12, to the neutral pin 25 of the plug 19. A sensing circuit 26 of the device 20 is connected between the neutral socket 29 and a neutral pin 27. The sensing circuit 26 is illustrated in more detail in FIG. 3.

As will be seen from FIG. 2, the circuit 26 will detect an interruption if the plug 19 is withdrawn from the socket connectors 28, 29 of the device 20, or if the device 20 itself is withdrawn from the supply outlet as well as switching of the circuit via the switch 17. Likewise, failure of the power supply entirely will also produce the same result.

Although described hereinabove with reference to it application to a plug or adapter, a circuit of FIG. 3 may be directly incorporated within an appliance.

Turning now to the embodiment shown in FIG. 3 this shows a plug 18 having a standard body or base 51 and an enlarged back cover 52 which houses the sensor and alarm circuit, for example the circuit illustrated in FIG. 5. The base 51 of the plug 18 carries three connector pins in the usual way, comprising an earth pin 53, a live pin 54 and a neutral pin 55. The live pin 54 is connected to a fuse clip 56 within the base 51, which receives a fuse 58 engaged at its other end in a combined fuse clip and connector clamp 59 for receiving and clamping a wire of a cable (not shown) in the usual way.

The neutral pin 55 has a corresponding clamp block 57 within the base 51.

The modified back 52 housing the circuit which will be described in relation to FIG. 5 has a contact spring 60 positioned such that when the back 52 is fitted over the base 51 it presses against the contact clamp 59, and a second contact spring 61 is positioned to engage the clamp block 57. Thus, in the assembled position, the contacts 60 and 61 are respectively electrically connected to the live pin 54 and neutral pin 55 so that, when the plug is inserted into a socket they receive the AC high voltage current which also passes from the plug to the appliance being supplied.

The circuit 26 of FIG. 4, may, of course, be incorporated directly into an appliance, like the embodiment of FIG. 3. It will be described here, however, with specific reference to its use in the plug 18 without any loss of generality thereby. In FIG. 3, the two contact springs 60, 61 comprise the input terminals to the circuit 26. In

FIGS. 1 and 2 these inputs are made via the pins 23, 27 respectively. The terminal 60 is connected via fuse 62 to a diode 63 which acts, in the usual way, as a half-wave rectifier supplying a positive supply rail 78 of the circuit. The positive supply rail 78 is connected via a suppressor capacitor 64 to the ground rail 79 supplied by the neutral terminal 61.

The half-wave rectified signal from the diode 63 is converted in the power supply circuit 65 to a smoothed DC current which is supplied on two outputs 68, 69 respectively at 15 volts and 5 volts. Biasing resistors 66, 67 across the input of the power supply circuit 65 determine the ratio of the output voltages.

The output voltage from the output 69 is supplied via resistor 73 to the gate of a field effect transistor 74 connected across a capacitor 75 connected between ground and an input 76 disc of a timer circuit 72. A timing input 84 of the timer 77 receives a voltage divided between two resistors 85, 86 the ratio of values of which determines the mark-to-space ratio in the output from the timer 77, which is supplied on line 87. The higher value DC output on line 68 is fed via two main capacitors 71, 72 to the positive biasing input 88 of the timer 77.

The output from the timer 77 is produced on line 87 and controls the operation of a piezo-electric alarm 83 which is connected in parallel with a light-emitting diode 82 having a series resistor 81 between the main DC rail 68 and the control line 87 at the output of the timer circuit 77.

The circuit described above operates as follows: when the back 52 is fitted to the base 51 of the plug 18 the terminals 60,61 engage the pins 54, 55 so that when, subsequently, the plug 18 is inserted into a socket, alternating current is supplied to these terminals. The half-wave rectified current applied to the input of the power supply circuit 65 gives rise to the DC output as described above on lines 68,69, which causes steady charging of the capacitors 71, 72 until they are fully charged. At the same time the lower-value voltage on the output line 69 from the power supply circuit 65 fed via the resistor 73 to the gate of the field-effect transistor 74 causes this to be conductive thereby short circuiting the capacitor 75 and maintaining the input 76 at the ground value of the neutral terminal 61. The timer 77 is thus turned off and the output on line 87 is maintained at the 15 volt level applied to the biasing terminal 88 so that no current flows through the light-emitting diode 82 or the piezo-electric alarm 83. If, at this point, the power supply across the terminals 60 and 61 should fail, either from a failure in the mains network, or by switching off the switch socket, or even by withdrawal of the plug from the socket, the voltage applied to the power supply circuit 65 falls immediately to zero and the outputs on lines 68 and 69 likewise fall to zero. The field-effect transistor 74 is now rendered non-conductive allowing the capacitor 75 to begin charging through the series resistors 85, 86 from the 15 volt line 68 which, now, is maintained at 15 volts by the capacitors 71, 72. The timer 77 is thus switched on and periodically allows the output voltage on line 87 to fall to the ground value so that the piezo-electric alarm 83 is periodically sounded and the light-emitting diode 82 periodically illuminated. The period is determined by the mark-to-space ratio of the timer 77 which, as mentioned above, is itself determined by the relationship between the values of the biasing resistors 85, 86 at the input to the timer 77. Typically this mark-to-space ratio will be 6:1 or more so that as the capacitors 71, 72 gradually discharge through the alarm 83 and light-emitting diode 82 the length of time for which they remain activated is extended approximately by a factor of 6. It is also significant to note that an intermittent signal is more noticeable by the human ear than a continuous signal so the volume of the acoustic output from the alarm 83 does not have to be very high in order for it to be easily noticeable. The alarm continues to sound until the capacitors 71 and 72 are discharged and thereafter is silenced. However, this alarm is of sufficient duration and intensity to alert the user to a potential failure of the supply to the equipment being supplied through the plug of which the alarm circuit forms part.

The circuit illustrated in FIG. 5 may also be incorporated in a plug, an adaptor or an appliance as desired in different circumstances. It represents a more economical version using low cost components. As can be seen the circuit comprises input terminals 29, 30 defining positive and neutral rails 31, 32 respectively. The positive rail contains a voltage dropping resistor 33 and a half-crane rectifier diode 34 connected to the base of an npn transistor 35 the emitter of which is connected to the reset input of a binary ripple counter 36.

The ripple counter 36 has a Vcc input 37 connected to the collector of the transistor 35 and to a circuit node 53 connected to the biasing inputs of two gates 39, 40 and to ground via a main storage capacitor 41 which has a zenerdiode 42 in parallel thereto operating to regulate the circuit to 12 volts.

The emitter of the transistor 35 is connected to the reset input 38 of the binary ripple counter 36 so as to hold this “off” whenever there is a power supply connected between the terminals 29, 30 and thus a voltage appearing at the emitter.

An RC circuit comprising resistor 47 and capacitor 46 are connected in parallel to oscillator inputs 41, 42 of the ripple counter 36 and to a clock input 43. Respective sets of outputs 44, 45 from the ripple counter 36 lead to inputs to the gates 39, 40. Gate 39 has an output leading via a resistor 48 to a light-emitting diode 49 the anode of which is connected to the ground line 32, and gate 40 has an output leading to a piezo electric acoustic transducer 50 which likewise is grounded at its other terminal.

In operation of the circuit described above the binary ripple counter 36 is held off, as mentioned above, by the transistor 35 applying the half-wave rectified signal coming from the diode 34 to its reset input 38 when mains voltage is applied across the terminals 29,30. At the same time this causes the capacitor 41 to charge gradually to a maximum of 12 volts, limited by the zenerdiode 42. Charging time for the capacitor 41 is about 10 seconds.

When the voltage across the terminals 29, 30 fails, for example because the plug 18 is withdrawn, or the mains voltage suffers an interruption, or even if the switch 16 is inadvertently turned off, the reset signal on input 38 is removed and the oscillator circuit 46,47 becomes active, causing the binary ripple counter 36 to cycle through a 14 stage binary count. The outputs 44, 45 are activated as the counter increments through its count. The selection of outputs to which the gates 39, 40 are connected allows a selection of different tones and sequences with different outputs. The gate 40 supplies a 4 kilohertz signal to the acoustic transducer 50 and the gate 39 provides a pulsing signal to the light-emitting diode 49. As the binary ripple counter cycles through its count it wraps around and repeats the count continuously until the capacitor 41 is discharged both through the ripple counter 36 itself (providing the power to the Vcc input 37) and biasing the gates 39, 40.

Biasing for the transistor 35 is achieved via the capacitor/resistor combination comprising capacitor 51 and resistor 52 which connect the reset input 38 to the ground line 32.

Thus, again, the circuit comprises an entirely self-contained detector and alarm, requiring no separate power source or battery, operating to store energy from the mains when connected thereto in order to provide an output signal for a limited time period after removal of the mains power for any reason.

In other embodiments (not shown) the acoustic transducer may be driven by a voice synthesiser. This may be programmable to identify the individual electrical appliance to which it is connected. A short range radio transmitter may also be incorporated, acting, when energised, to trigger a remote alarm if the device is used for high security purposes.

What is claimed is:

1-24. (canceled)

25. A self-contained electrical appliance alarm device for monitoring the electrical supply status of the electrical appliance, the device being connectable in the electrical supply line from the mains to the appliance, wherein the device is operable to provide an audible and/or visible alarm signal if the electrical supply to the appliance is interrupted after connection, and is operable in the absence of an internal power source or battery.

26. The self-contained alarm device as claimed in claim 25, in which the device is operable to store energy from the mains when connected thereto and to use the stored energy to provide the alarm signal for a limited time after interruption of the mains electrical supply.

27. The self-contained alarm device according to claim 25, characterized in that it is formed as a adaptor with pins for insertion into a socket and having socket connections for receiving the pins of a connector plug of the monitored appliance.

28. The self-contained alarm device according to claim 26, characterized in that it is formed as a adaptor with pins for insertion into a socket and having socket connections for receiving the pins of a connector plug of the monitored appliance.

29. The self-contained alarm device according to claim 25, characterized in that it is incorporated into a plug for connection to a mains supply socket.

30. The self-contained alarm device according to claim 25, characterized in that there are provided means for detecting an open-circuit condition of a monitored supply line.

31. The self-contained alarm device according to claim 25, characterized in that it includes a delay timer for delaying operation of an output device triggering the alarm indication for a pre-determined delay period after detection thereof.

32. The self-contained alarm device according to claim 31, characterized in that said output device is a relay.

33. The self-contained alarm device according to claim 25, characterized in that it has a capacitor which is maintained charged when the supply is present and which is arranged to discharge when the supply is removed.

34. The self-contained alarm device according to claim 25, characterized in that the open circuit condition is detected by sensing a reversal in the polarity of a voltage differential across a resistive element.

35. The self-contained alarm device according to claim 33, characterized in that the said capacitor provides the power for an audible and/or visible alarm indicator upon the occurrence of an alarm condition.

36. The self-contained alarm device according to claim 34, characterized in that the said capacitor provides the power for an audible and/or visible alarm indicator upon the occurrence of an alarm condition.

37. The self-contained alarm device according to claim 35, characterized in that the alarm indicator device is supplied intermittently when a power failure is detected, whereby to give the alarm indication.

38. The self-contained alarm device according to claim 37, characterized in that the mark-to-space ratio of the alarm signal is determined by the ratio of the values of two series-connected resistors in the input circuit of a timer.

39. The self-contained alarm device according to claim 33, characterized in that a secondary output from the power supply is applied to the timer circuit to maintain it in a quiescent condition as long as the power is supplied to the circuit.

40. An electrical appliance alarm device for connection to the electrical supply line from the mains to the appliance, the device being adapted for incorporation into the electrical appliance, wherein the device is operable to monitor the electrical supply status of the electrical supply line and to provide an audible and/or visible alarm signal if the electrical supply to the appliance is interrupted after connection, and is operable in the absence of an internal power source or battery.

41. The alarm device as claimed in claim 40, in which the device is operable to store energy from the mains when connected thereto and to use the stored energy to provide the alarm signal for a limited time after interruption of the mains electrical supply.

42. The alarm device according to claim 40, characterized in that there are provided means for detecting an open-circuit condition of a monitored supply line.

43. The alarm device according to claim 41, characterized in that there are provided means for detecting an open-circuit condition of a monitored supply line.

44. The alarm device according to claim 40, characterized in that it includes, a delay timer for delaying operation of an output device triggering the alarm indication for a pre-determined delay period after detection thereof.

45. The alarm device according to claim 42, characterized in that it includes, a delay timer for delaying operation of an output device triggering the alarm indication for a pre-determined delay period after detection thereof.

46. The alarm device according to claim 44, characterized in that the delay timer is adjustable.

47. The alarm device according to claim 44, characterized in that the said output device is a relay.

48. The alarm device according to claim 46, characterized in that the said output device is a relay.

49. The alarm device according to claim 40, characterized in that it has a capacitor which is maintained charged when the supply is present and which is arranged to discharge when the supply is removed.

50. The alarm device according to claim 42, characterized in that the open circuit condition is detected by sensing a reversal in the polarity of a voltage differential across a resistance element.

51. The alarm device according to claim 49, characterized in that the said capacitor provides the power for an audible and/or visible alarm indicator upon the occurrence of an alarm condition.

52. The alarm device according to claim 50, characterized in that the said capacitor provides the power for an audible and/or visible alarm indicator upon the occurrence of an alarm condition.

53. The alarm device according to claim 40, characterized in that in operation when a power failure is detected the alarm indicator device is supplied intermittently to give the alarm indication.

54. The alarm device according to claim 53, characterized in that the mark-to-space ratio of the alarm signal is determined by the ratio of the values of two series-connected resistors in the input circuit of a timer.

55. The alarm device according to claim 44, characterized in that a secondary output from the power supply is applied to the timer circuit to maintain it in a quiescent condition as long as the power is supplied to the circuit.
